(19) United States
(12) Patent Application Publication
(10) Pub. No.: US 2026/0248113 A1
(43) Pub. Date: Aug. 27, 2026

(54) GECKO EGG REMOVAL DEVICE WITH A REMOVABLE INNER SHELL

(71) Applicant: Joseph Lomascolo, River Grove, IL (US)

(72) Inventor: Joseph Lomascolo, River Grove, IL (US)

(21) Appl. No.: 19/063,002

(22) Filed: Feb. 25, 2025

(51) Int. Cl. A01K 63/00

(52) U.S. Cl. CPC A01K 63/006

(57) ABSTRACT

A gecko egg removal device is provided. The gecko egg removal device includes an outer shell and an inner shell. The outer shell includes a tubular body, a first end, and a second end. The tubular body of the outer shell defines a cavity. The second end of the outer shell is longitudinally opposed to the first end of the outer shell. The first end of the outer shell is enclosed by an outer end wall configured to retain the inner shell. The second end of the outer shell is configured to receive the inner shell. The inner shell has a first end enclosed by an inner end wall and a second end that defines an opening for a gecko. The inner shell is removably inserted into the outer shell.

### BACKGROUND

The present disclosure relates generally to the field of gecko egg removal devices. More specifically, the present application relates to a gecko egg removal device having a removable inner shell.

### SUMMARY

One embodiment of the present disclosure relates to a gecko egg removal device. The gecko egg removal device includes an outer shell and an inner shell. The outer shell includes a tubular body, a first end, and a second end. The tubular body of the outer shell defines a cavity. The second end of the outer shell is longitudinally opposed to the first end of the outer shell. The first end of the outer shell is enclosed by an outer end wall configured to retain the inner shell. The second end of the outer shell is configured to receive the inner shell. The inner shell has a first end enclosed by an inner end wall and a second end that defines an opening for a gecko. The inner shell is removably inserted into the outer shell.

In some embodiments, the gecko egg removal device further includes a first magnet and a second magnet. The first magnet is of a planar outer surface of the outer shell. The planar outer surface of the outer shell is configured to couple to an interior surface of an environmental enclosure. The second magnet is configured to couple with an exterior surface of the environmental enclosure to retain the outer shell in an elevated position. In some embodiments, the outer shell further includes a first magnet configured to magnetically couple with a second magnet of the inner shell to retain the inner shell within the cavity of the outer shell. In some such embodiments, the first magnet is integral to the outer end wall of the outer shell and the second magnet is integral to the inner end wall of the inner shell. In some embodiments, the inner end wall of the inner shell defines a plurality of apertures. In some such embodiments, the outer end wall of the outer shell defines a second plurality of apertures. In some embodiments, the tubular body of the outer shell is a polygonal tubular body configured to receive a polygonal tubular body of the inner shell according to a plurality of relative rotations between the outer shell and the inner shell. In some such embodiments, the first plurality of apertures is configured to align with the second plurality of apertures according to each of the plurality of relative rotations. In some embodiments, the outer end wall of the outer shell defines a first plurality of apertures, the inner end wall of the inner shell defines a second plurality of apertures, and at least one of the first plurality of apertures aligns with at least one of the second plurality of apertures. In some embodiments, the tubular body of the outer shell defines one or more elongated apertures. In some embodiments, the tubular body of the outer shell is a hexagonal tubular body.

One embodiment of the present disclosure relates to a gecko egg removal device. The gecko egg removal device includes an outer shell, a first portion of a suspension system, and a second portion of the suspension system. The outer shell has an inner surface defining a cavity configured to receive an inner shell. The first portion of the suspension system is configured to couple with the second portion of the suspension system. The second portion of the suspension system is configured to couple the outer shell with an environmental enclosure.

In some embodiments, the outer shell comprises a plurality of inner surfaces. Each of the plurality of inner surfaces defines a cavity configured to receive an inner shell. In some embodiments, the outer shell further includes a retention component configured to releasably retain the inner shell within the cavity. In some such embodiments, the retention component comprises a first magnet of the inner surface configured to couple with a second magnet of the inner shell. In some embodiments, the first portion of the suspension system includes a first magnet, and the second portion of the suspension system includes a second magnet configured to couple with the first magnet. In some embodiments, the inner shell includes an inner ventilating portion. In some such embodiments, the inner ventilating portion defines an aperture. In some embodiments, the outer shell includes an outer ventilating portion. In some such embodiments, the outer ventilating portion defines at least one aperture in the outer shell. In some embodiments, the gecko egg removal device includes the inner shell.

One embodiment of the present disclosure relates to a method of incubation. The method includes the step of providing, into a gecko environment, a gecko egg removal device having an outer shell with a cavity configured to receive an inner shell. The method includes the step of inserting a first inner shell into the cavity of the outer shell. The method includes the step of removing the first inner shell once eggs have been laid therein. The method includes conveying the inner shell to an incubation environment.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIGS. 1A, 1B, 1C, 1D, 1E, and 1F are perspective views of a gecko egg removal device, according to some embodiments of the present disclosure;

FIG. 2 is a cross-sectional side view of the gecko egg removal device of FIGS. 1A-1F, according to some embodiments of the present disclosure;

FIG. 3 is a side view of the gecko egg removal device of FIGS. 1A-1F coupled to an inside surface of an environmental enclosure, according to some embodiments of the present disclosure;

FIG. 4 is a cross-sectional side view of the gecko egg removal device of FIGS. 1A-1F coupled to an inside surface of an environmental enclosure, according to some embodiments of the present disclosure;

FIG. 5 is a side view of the gecko egg removal device of FIGS. 1A-1F with an inner shell partially inserted into an outer shell, according to some embodiments of the present disclosure; and

FIG. 6 is a flow diagram of a method of incubating gecko eggs, according to some embodiments of the present disclosure.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Geckos may be kept in an environmental enclosure (e.g., a tank, a tub, a cage, etc.) where they can live, be provided for, and be observed. Some species of geckos lay eggs that become attached to the surface on which they are laid. If such eggs are laid in an environmental enclosure, attempts to move the eggs to another enclosure (e.g., an incubator, another environmental enclosure, etc.) may damage the eggs and threaten their viability. If the eggs are allowed to hatch in the environmental enclosure in which the eggs are laid, the hatchlings, owing to their small size, may escape the environmental enclosure through openings not navigable by larger geckos. If the eggs hatch in an environmental enclosure housing another gecko, the hatchlings may be eaten by the other gecko. Furthermore, some species of geckos lay eggs frequently. The accumulation of eggs in an environmental enclosure may adversely affect the egg laying habits of such geckos (e.g., the frequency with which they lay eggs, the location at which they lay eggs, etc.).

Referring generally to the FIGURES, a gecko egg removal device is provided. The gecko egg removal device includes an outer shell. The gecko egg removal device may additionally include a suspension system to selectively position and couple the outer shell to an inside surface of an environmental enclosure (e.g., in a location above a bottom of the environmental enclosure). The outer shell has a cavity in which an inner shell may be releasably inserted. The inner shell has a cavity sized and configured to allow a gecko to enter, hide, rest, and eventually lay eggs. When a gecko has laid eggs within the inner shell, the inner shell may be removed from the outer shell, conveyed to an incubation environment, and replaced with a second inner shell. The eggs laid in the inner shell may be incubated within the inner shell. Accordingly, the gecko egg removal device disclosed herein, and the method of incubation that the gecko egg removal device promotes, provide a system and a method for removing gecko eggs laid in an environmental enclosure to an incubation environment without threatening the integrity or viability of the eggs.

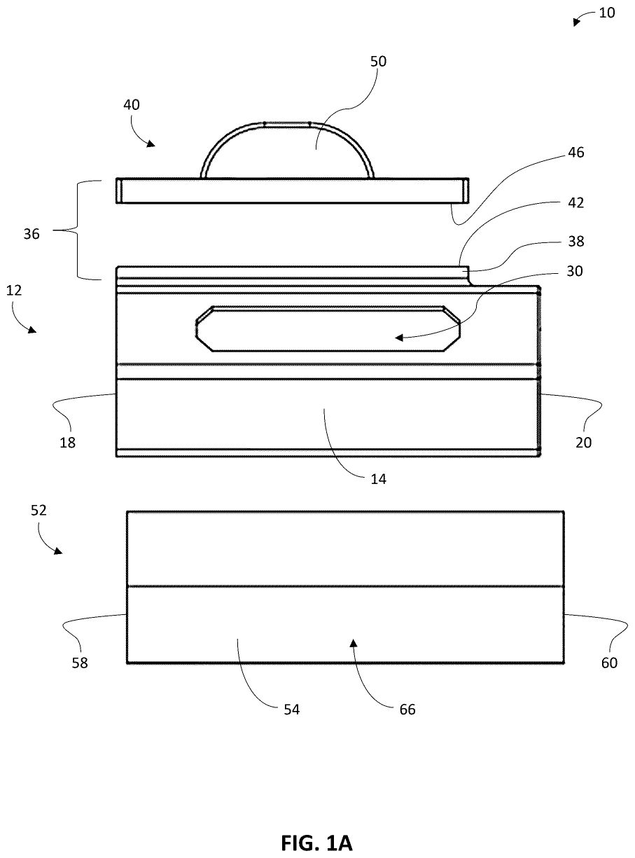

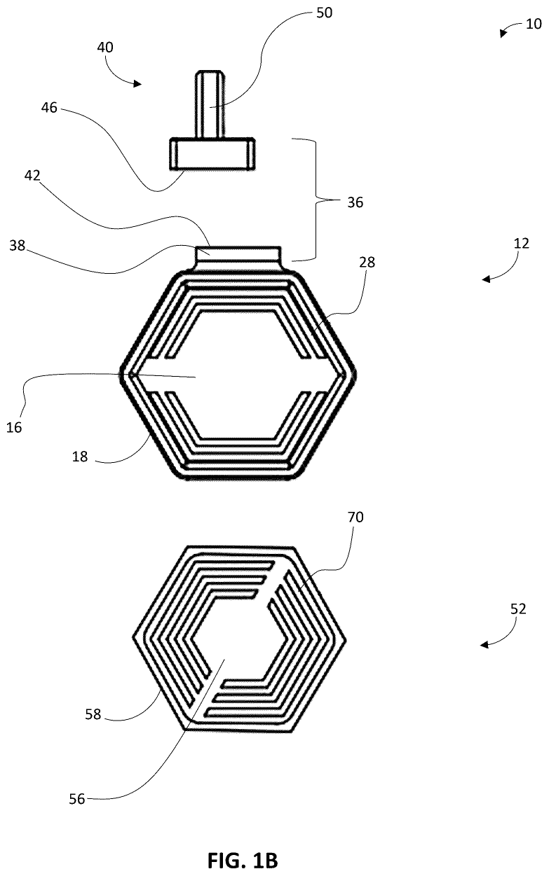

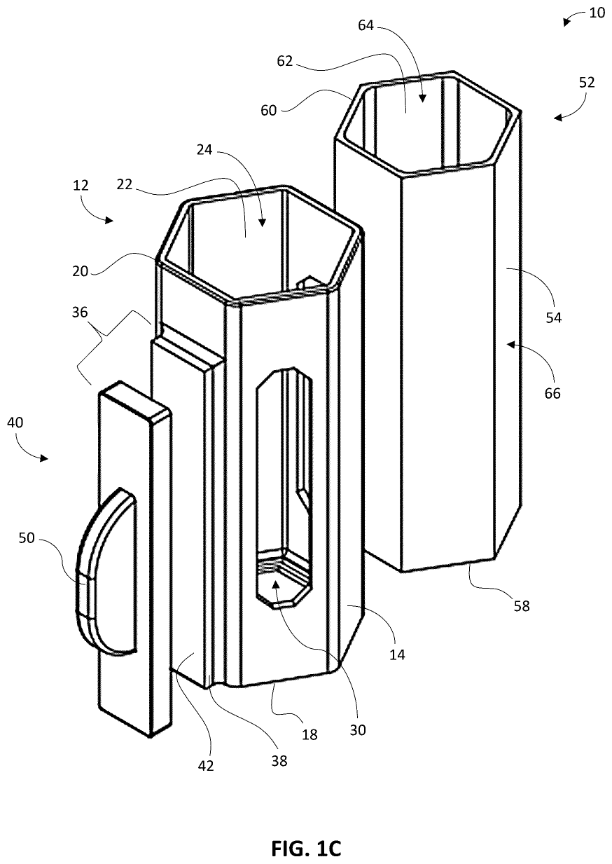

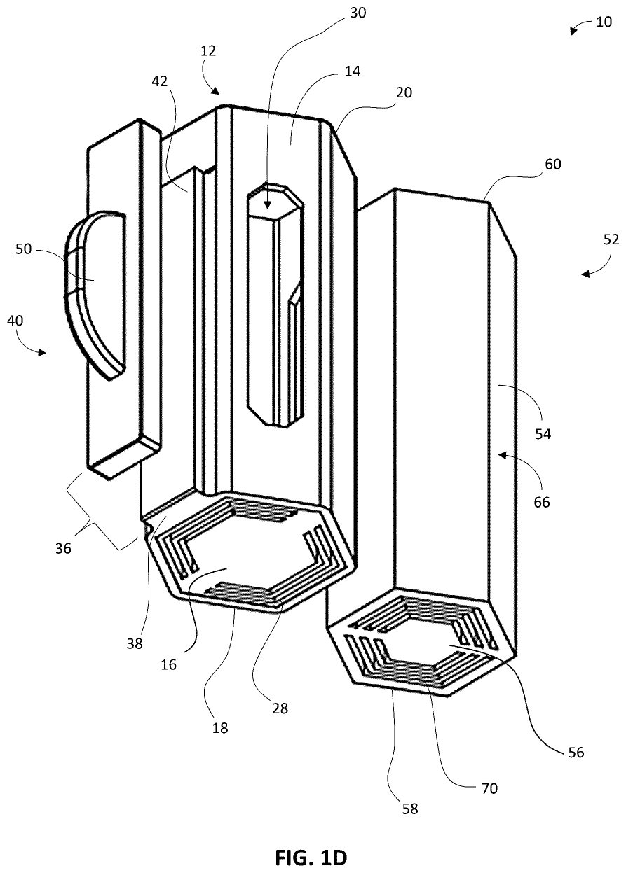

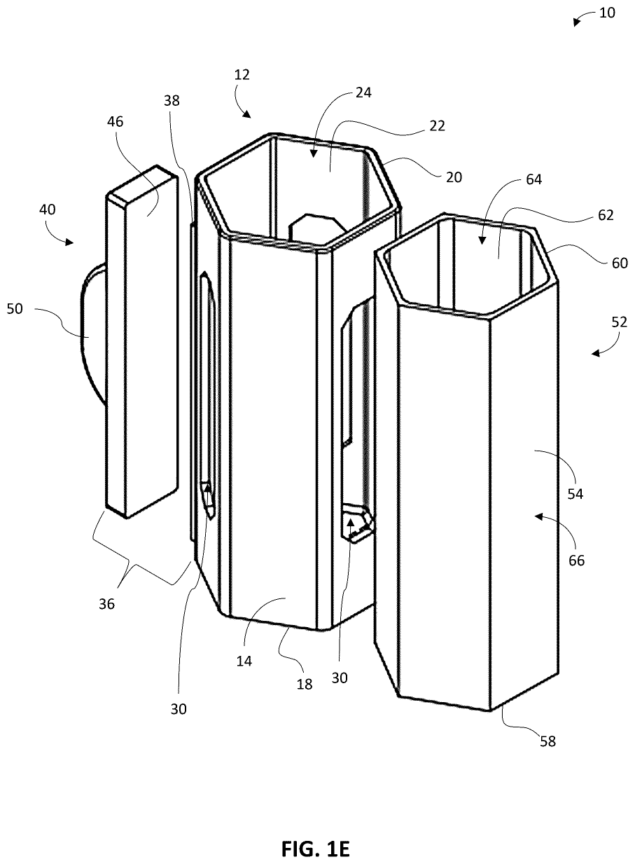

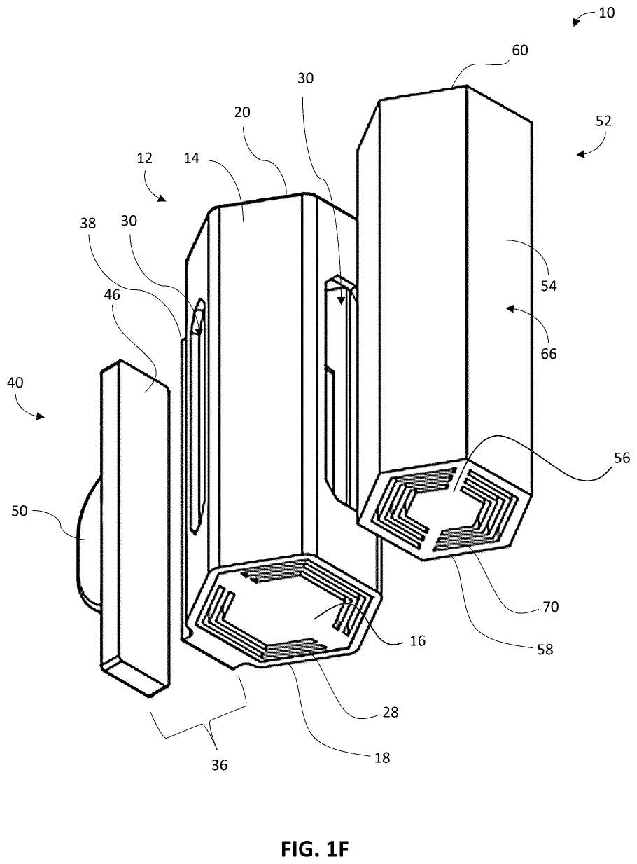

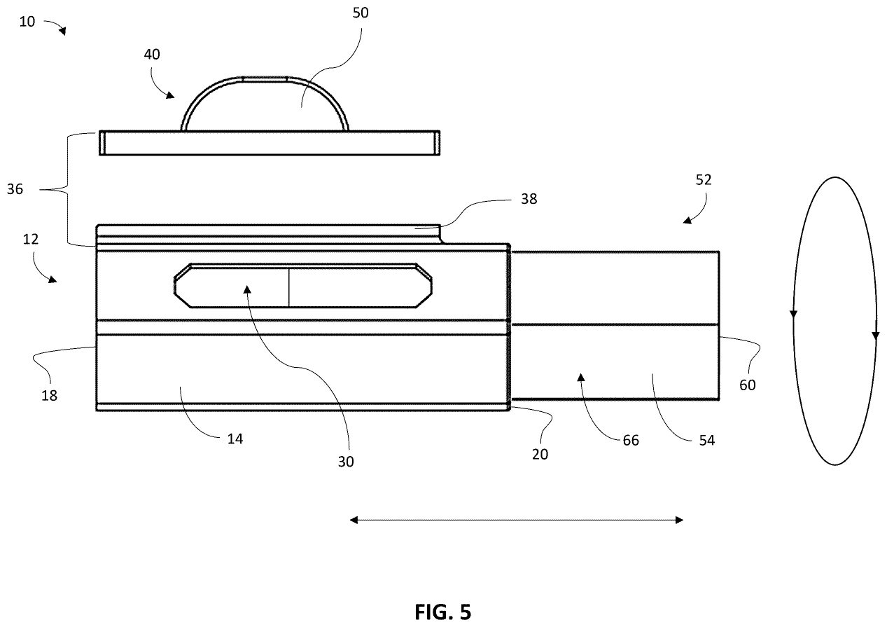

In accordance with some embodiments of the present disclosure, and as shown in FIGS. 1A-5, a gecko egg removal device 10 includes an outer shell 12. The outer shell 12 is configured to releasably receive an inner shell. The outer shell 12 has a hollow tubular body 14 and an end wall 16. For example, one end of the tubular body 14 can terminate at the end wall 16. The tubular body 14 of the outer shell 12 is sometimes referred to as an “outer” tubular body 14, and the end wall 16 of the outer shell 12 is sometimes referred to as an “outer” end wall 16 without limiting effect. Such a nomenclature can be used to distinguish from other tubular bodies or end walls (e.g., the “inner” tubular body 54 or end wall 56 of the inner shell 52). Such a nomenclature should not be construed to infer that the outer shell 12 is mated with the inner shell 52. For example, the tubular body 14 of the outer shell 12 may be referred to as an outer tubular body 14 when separate from, mated with, or partially mated with, other components of a gecko egg removal device 10.

The outer tubular body 14 extends between a first end 18 and a longitudinally opposed second end 20 (e.g., a second end disposed opposite the first end 18 along an axis defined by a length of the outer tubular body 14). In some embodiments, the outer tubular body 14 is a cylindrical tubular body (e.g., a tubular body having a circular cross section). In some embodiments, the outer tubular body 14 is a polygonal tubular body (e.g., a tubular body having a polygonal cross section). For example, the outer tubular body 14 can be a hexagonal tubular body having a hexagonal cross section.

The outer tubular body 14 of the outer shell 12 has an inner surface 22. For example, an inner surface 22 of a polygonal tubular body can include various planar surface sections that meet to form a contiguous surface (e.g., an inner surface 22 for a hexagonal tubular body has six planar surface sections that meet to form a contiguous hexagonal surface). The outer shell 12 is enclosed by the outer end wall 16 at the first end 18 (e.g., protruding beyond or recessed from the first end 18). The inner surface 22 of the outer tubular body 14 (e.g., the plurality of surface sections thereof) and an inner surface of the outer end wall 16 define a cavity 24. The second end 20 of the outer tubular body 14 is open (e.g., defines or includes an aperture) to the cavity 24 such that an inner shell 52 may be received into the cavity 24, axially, through the second end 20 of the outer tubular body 14.

In some embodiments of the present disclosure, the outer end wall 16 has an outer ventilating portion. The outer ventilating portion of the outer end wall 16 promotes a flow of air between the cavity 24 and the ambient environment. In some embodiments, the outer ventilating portion of the outer end wall 16 defines one or more apertures 28 (e.g., holes, perforations, slits, etc.). The one or more apertures 28 of the outer ventilating portion of the outer end wall 16 allow gaseous communication between the cavity 24 and the ambient environment to promote the flow of air between the cavity 24 and the ambient environment within an enclosure.

The outer tubular body 14 can define one or more viewing apertures 30 to provide visibility into the cavity 24. The one or more viewing apertures 30 may be elongated apertures (e.g., having a length that is greater than a height) extending along an axis defined by a length of the outer tubular body 14. The one or more viewing apertures 30 may be evenly spaced about a circumference of the outer tubular body 14. The viewing apertures 30 can be implemented as transparent walls. The viewing apertures 30 can be implemented as an opening, through which a user can grasp an outer wall of an inner tubular body 54 (e.g., to aid insertion or removal of the inner tubular body 54 from the outer tubular body 14).

In some embodiments of the present disclosure, the outer end wall 16 includes an outer retention component. The outer retention component is configured to releasably retain an inner shell within the cavity 24 of the outer shell 12, once inserted. In some embodiments, the outer retention component includes an outer retention magnet 34. The outer retention magnet 34 of the outer retention component is positioned and oriented to magnetically couple with a component (e.g., a second magnet, a ferro-metallic component, etc.) of an inner shell 52 inserted within the cavity 24 of the outer shell 12. In some embodiments, the outer retention magnet 34 can be substituted for another ferro-metallic component configured to couple with an inner retention magnet 74 of the inner shell 52. The retention magnet exerts an attractive force strong enough to retain an inner shell within the cavity 24 of the outer shell 12 (e.g., greater than a weight of the inner shell 52) but weak enough that the inner shell can be manually removed from the cavity 24.

In some embodiments, the outer retention magnet 34 is integral to the outer end wall 16 or along the tubular body. In some embodiments, the outer retention magnet 34 of the outer retention component is fixed to the inner surface of the outer end wall 16 such that the magnet is disposed within the cavity 24 of the outer shell 12. In some embodiments, the outer retention component is a component configured to apply tension (e.g., a tensioner) to an inner shell received within the cavity 24 of the outer shell 12 to releasably retain the inner shell within the cavity 24 (e.g., one of the outer shell 12 or the inner shell 52 can be tapered to apply a clamping force therebetween). In some embodiments, the outer retention component is a mechanical coupler configured to releasably couple with an inner shell received within the cavity 24 of the outer shell 12 to retain the inner shell within the cavity 24.

In accordance with some embodiments of the present disclosure, the gecko egg removal device 10 includes a suspension system 36. The suspension system 36 can position and selectively couple the outer shell 12 with an inside surface of an environmental enclosure (e.g., in a position elevated above a bottom of the enclosure). The suspension system 36 can include a first portion 38 and a second portion 40. The first portion 38 of the suspension system 36 can be coupled, or integral, to the outer shell 12. As shown in FIGS. 1A-5, the first portion 38 of the suspension system 36 may be formed integrally to an exterior, radial portion of the outer tubular body 14 (e.g., a portion of the outer tubular body 14 opposite the inner surface 22 of the outer tubular body 14).

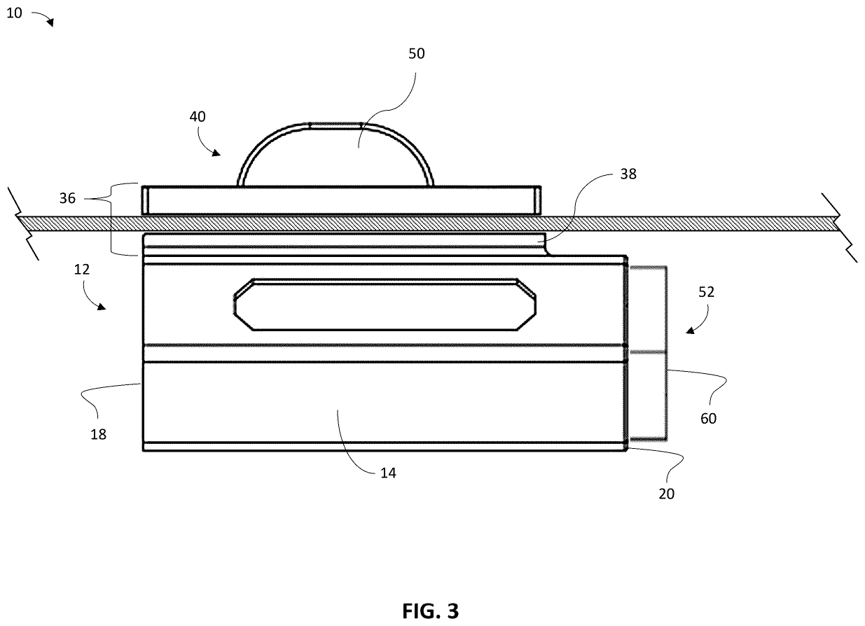

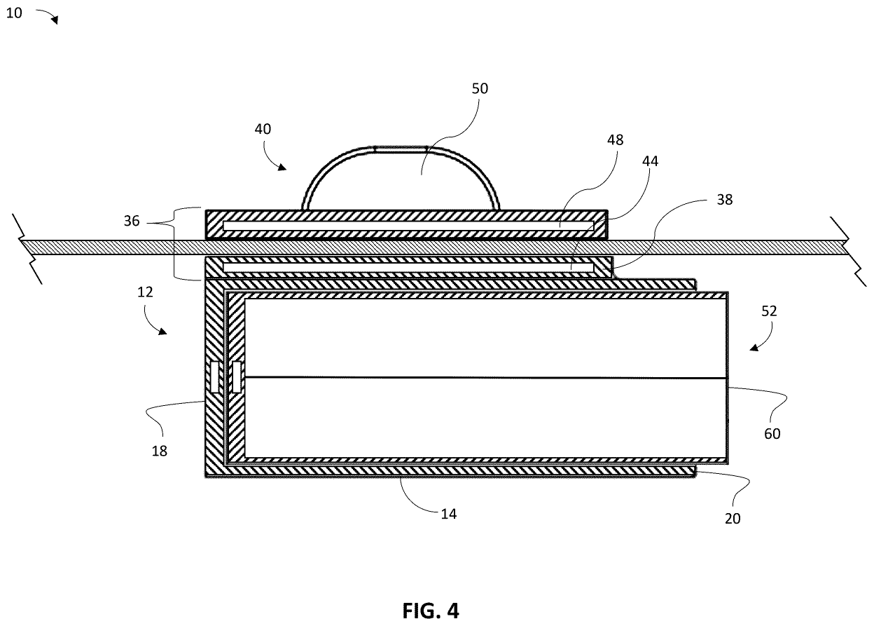

The first portion 38 of the suspension system 36 can include a first mating surface 42. The first mating surface 42 is a planar outer surface of the first portion 38 of the suspension system 36 (e.g., a surface of the first portion 38 of the suspension system 36 opposite the outer tubular body 14 of the outer shell 12). As shown in FIGS. 3 and 4, the first mating surface 42 is configured to be placed against an interior surface of an environmental enclosure.

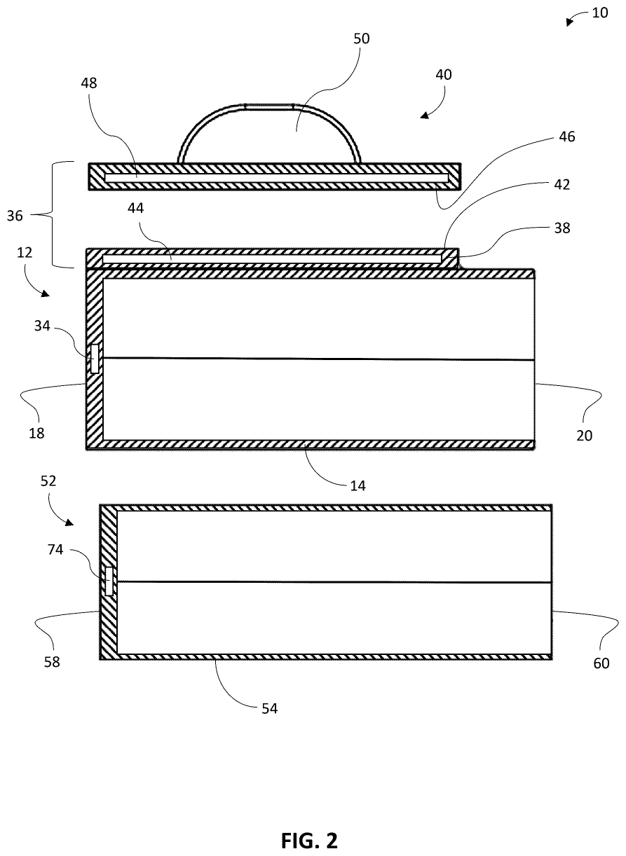

The first portion 38 of the suspension system 36 can include a first coupling magnet 44 positioned and oriented to magnetically couple with a component (e.g., a second magnet, a ferro-metallic component, etc.) of the second portion 40 of the suspension system 36 placed against a corresponding exterior surface of the environmental enclosure. The first coupling magnet 44 exerts an attractive force strong enough to couple the first portion 38 of the suspension system 36 to the second portion 40 of the suspension system 36 but weak enough that the outer shell 12, to which the first portion 38 of the suspension system 36 is attached, can be manually removed from the environmental enclosure. As shown in FIGS. 2 and 4, the first coupling magnet 44 can be integral to the first portion 38 of the suspension system 36 and positioned to exert an attractive magnetic force perpendicular to the first mating surface 42. In some embodiments, the first coupling magnet 44 is fixed to a surface of the first portion 38 of the suspension system 36; a surface of the first coupling magnet 44 can form the first mating surface 42 of the first portion 38 of the suspension system 36.

As shown in FIGS. 1A-5, the second portion 40 of the suspension system 36 is a component structurally distinct from the outer shell 12. The second portion 40 of the suspension system 36 can include a second mating surface 46 and a second coupling magnet 48. The second mating surface 46 can include a planar outer surface of the second portion 40 of the suspension system 36. The second mating surface 46 can be configured for placement against an exterior surface of an environmental enclosure (e.g., a portion of an exterior surface of an environmental enclosure corresponding to a portion of an interior surface of the environmental enclosure against which the first portion 38 of the suspension system 36 is placed). The second coupling magnet 48 can be configured and oriented to magnetically couple with a component (e.g., the first coupling magnet 44, a ferro-magnetic component, etc.) of the first portion 38 of the suspension system 36 placed against a corresponding interior surface of the environmental enclosure. The second coupling magnet 48 exerts an attractive force strong enough to couple the second portion 40 of the suspension system 36 to the first portion 38 of the suspension system 36 but weak enough that the second portion 40 of the suspension system 36 may be manually decoupled from the first portion 38.

In some embodiments, the second coupling magnet 48 is integral to the second portion 40 of the suspension system and positioned to exert an attractive magnetic force perpendicular to the second mating surface 46 (e.g., as depicted in FIGS. 2 and 4). In some embodiments, the second coupling magnet 48 is fixed to a surface of the second portion 40 of the suspension system 36. In some such embodiments, a surface of the second coupling magnet 48 forms the second mating surface 46 of the second portion 40 of the suspension system 36.

In some embodiments of the present disclosure, the second portion 40 of the suspension system 36 has a handle member 50. The handle member 50 is configured to be gripped and to allow for manual manipulation, or positioning, of the second portion 40 of the suspension system 36. In some embodiments, and as shown in FIGS. 1A-5, the handle member 50 extends from a side of the second portion 40 of the suspension system 36 opposite the second mating surface 46. The handle member 50 of the second portion 40 of the suspension system 36 may be sized and configured to be gripped between a thumb and a forefinger. In some embodiments, the handle member 50 is integral to the second portion 40 of the suspension system 36. In some embodiments, the handle member is coupled (e.g., screwed, adhered, pinned, etc.) to the second portion 40 of the suspension system 36. In some embodiments, the suspension system 36 is one or more suction cups attached to the outer shell 12 and configured to couple the outer shell 12 to an inner surface of an environmental enclosure (e.g., at a position above a bottom of the environmental enclosure). In some embodiments, the suspension system 36 is one or more hooks attached to the outer shell 12 and configured to suspend the outer shell 12 from a wall of an environmental enclosure.

In accordance with some embodiments of the present disclosure, the gecko egg removal device 10 includes an inner shell 52. The inner shell 52 provides a space in which a gecko may enter and a surface on which the gecko may lay eggs. The inner shell 52 is removably insertable into the outer shell 12 so that, once a gecko has laid eggs in the inner shell 52, the inner shell 52 can be removed from the environmental enclosure and transported to an incubation environment. The inner shell 52 has an inner tubular body 54 and an inner end wall 56. As described above with regard to outer components, various inner components of the inner shell 52 of the gecko egg removal device 10 are so referred to, in order to distinguish from corresponding outer components of the outer shell 12 of the gecko egg removal device 10.

The inner tubular body 54 extends between a first end 58 and a longitudinally opposed second end 60 (e.g., a second end disposed opposite from the first end 58 along an axis defined by a length of the inner tubular body 54). In some embodiments, the inner tubular body 54 is a cylindrical tubular body (e.g., a tubular body having a circular cross section. In some embodiments, the inner tubular body 54 is a polygonal tubular body (e.g., a tubular body having a polygonal cross section). For example, the inner tubular body 54 can be a hexagonal tubular body having a hexagonal cross section.

The inner tubular body 54 has an inner surface 62. For example, an inner surface 62 of a polygonal tubular body can include various planar surface sections that meet to form a contiguous surface (e.g., an inner surface 62 of a hexagonal tubular body has six planar surface sections that meet to form a contiguous hexagonal surface). The inner shell 52 is enclosed by the inner end wall 56 at the first end 58 (e.g., protruding beyond or recessed from the first end 58). The inner surface 62 of the inner tubular body 54 (e.g., the plurality of surface sections thereof) and an inner surface of the inner end wall 56 define a cavity 64. The second end 60 of the inner tubular body 54 is open (e.g., defines or includes an aperture) to the cavity 64 such that a gecko may enter the cavity 64, through the second end 60, and lay eggs on the inner surface 62 of the inner tubular body 54.

The inner tubular body 54 has an outer surface 66 opposite the inner surface 62. For example, an outer surface 66 of a polygonal tubular body can include various planar surface sections that meet to form a contiguous surface (e.g., an outer surface 66 of a hexagonal tubular body has six planar surface sections that meet to form a contiguous hexagonal surface). The outer surface 66 of the inner tubular body 54 has a diameter that is less than a diameter of the inner surface 22 of the outer tubular body 14 of the outer shell 12 so that the inner shell 52 may be axially inserted into the cavity 24 of the outer shell 12. Where the inner tubular body 54 and the outer tubular body 14 are similarly shaped polygonal tubular bodies (e.g., tubular bodies having cross sections of the same shape), the shape of the inner tubular body 54 and the outer tubular body 14 may dictate that the inner shell 52 be inserted into the cavity 24 of the outer shell 12 at specific relative axial rotations between the inner shell 52 and the outer shell 12. For example, where the inner tubular body 54 and the outer tubular body 14 are both hexagonal tubular bodies, the inner shell 52 may be inserted into the cavity 24 of the outer shell 12 at six relative axial rotations between the inner shell 52 and the outer shell 12, each of the six relative rotations sixty degrees apart.

In some embodiments of the present disclosure, the inner end wall 56 has an inner ventilating portion. The inner ventilating portion of the inner end wall 56 promotes a flow of air between the cavity 64 and the ambient environment. In some embodiments, the inner ventilating portion of the inner end wall 56 defines one or more apertures 70 (e.g., holes, perforations, slits, etc.) through the inner end wall 56. The one or more apertures 70 of the inner ventilating portion allow gaseous communication between the cavity 64 and the ambient environment when the inner shell 52 is not inserted into the outer shell 12 (e.g., when the inner shell 52 is being stored, when the inner shell 52 is in an incubation environment, etc.) to promote the flow of air between the cavity 64 and the ambient environment when the inner shell 52 is not inserted into the outer shell 12. Gaseous communication between the ambient environment and the cavity 64 may prevent or mitigate condensation or mold formation within the cavity 64 during incubation.

The one or more apertures 70 are positioned on the inner end wall 56 of the inner shell 52 so that at least one of the one or more apertures 70 of the inner ventilating portion align with at least one of the one or more apertures 28 of the outer ventilating portion when the inner shell 52 is inserted into the cavity 24 of the outer shell 12. In some embodiments, the shape of the inner tubular body 54 and the outer tubular body 14 dictate that the inner shell 52 be inserted into the cavity 24 of the outer shell 12 at specific relative axial rotations between the inner shell 52 and the outer shell 12. The one or more apertures 70 of the inner ventilating portion can be positioned on the inner end wall 56 of the inner shell 52 so that at least one of the one or more apertures 70 of the inner ventilating portion align with at least one of the one or more apertures 28 of the outer ventilating portion. For example, apertures can align when the inner shell 52 is inserted into the cavity 24 of the outer shell 12, according to each of the dictated relative rotations. Such an alignment of the inner ventilating portion and the outer ventilating portion allows gaseous communication between the cavity 64 of the inner shell 52 and the ambient environment to promote the flow of air between the cavity 64, through the inner ventilating portion and the outer ventilating portion, and the ambient environment when the inner shell 52 is inserted into the outer shell 12.

In some embodiments of the present disclosure, the inner end wall 56 has an inner retention component. The inner retention component is configured to releasably retain the inner shell 52 within the cavity 24 of the outer shell 12 once inserted. In some embodiments, the inner retention component includes an inner retention magnet 74. The inner retention magnet 74 of the inner retention component is positioned and oriented to magnetically couple with a component (e.g., the outer retention magnet 34 of the outer retention component, a ferro-metallic component, etc.) of the outer shell 12 in which the inner shell 52 is inserted. In some embodiments, the inner retention magnet 74 can be substituted for another ferro-metallic component configured to couple with an outer retention magnet 34 of the outer shell. The retention magnet exerts an attractive force strong enough to retain the inner shell 52 within the cavity 24 of the outer shell 12 (e.g., greater than a weight of the inner shell 52) but weak enough that the inner shell 52 can be manually removed from the cavity 24.

In some embodiments, the inner retention magnet 74 is integral to the inner end wall 56 or along the tubular body. In some embodiments, the inner retention magnet 74 of the inner retention component is fixed to the outer surface of the inner end wall 56. In some embodiments, the inner retention component is a component configured to apply tension (e.g., a tensioner) to the outer shell 12 to releasably retain the inner shell 52 within the cavity 24 (e.g., one of the outer shell 12 or the inner shell 52 can be tapered to apply a clamping force therebetween). In some embodiments, the inner retention component is a mechanical coupler configured to releasably couple with the outer shell 12 to retain the inner shell within the cavity 24 of the outer shell 12.

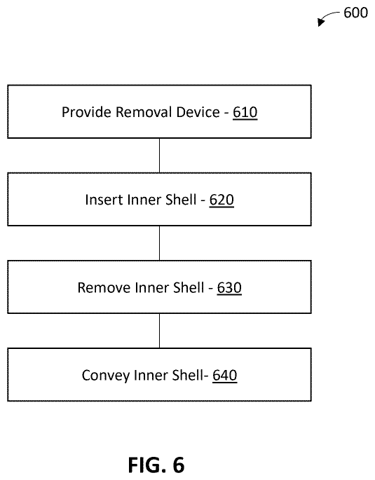

In accordance with some embodiments of the present disclosure, and as shown in FIG. 6, a method 600 of incubating gecko eggs is provided. The method 600 of incubating gecko eggs includes providing a gecko egg removal device (e.g., gecko egg removal device 10) into an environmental enclosure at operation 610. The gecko egg removal device may include an outer shell (e.g., outer shell 12) defining a cavity configured to receive an inner shell (e.g., inner shell 52). The gecko egg removal device may include a suspension system (e.g., suspension system 36) configured to couple the outer shell to an inner surface of an environmental enclosure (e.g., in a position above a bottom of the environmental enclosure). At operation 610, the gecko egg removal device 10 may include coupling the egg removal device to the inner surface of the environmental enclosure. The suspension system may include a first portion (e.g., first portion 38) integral to the outer shell and a structurally independent second portion (e.g., second portion 40) configured to magnetically couple with the first portion of the suspension system. Operation 610 may include placing a mating surface of the first portion of the suspension system against an inner surface of the environmental enclosure and placing a mating surface of the second portion against a corresponding outer surface of the environmental enclosure to couple the inner shell to the inner surface of the environmental enclosure.

The method 600 of incubating gecko eggs includes inserting an inner shell (e.g., inner shell 52) into the outer shell of the gecko egg removal device at operation 620. The inner shell may be configured to be releasably inserted into the outer shell of the gecko egg removal device. The inner shell defines a cavity in which a gecko may enter, hide, rest, and lay eggs. The inner shell may be insertable into the outer shell of the gecko egg removal device at specific relative rotations between the inner shell and the outer shell of the gecko egg removal device (e.g., to align polynomial cross sections).

The method 600 of incubating gecko eggs includes removing the inner shell when gecko eggs have been laid therein at operation 630. The inner shell may be axially removable from the outer shell. Removing the inner shell (as may include gecko eggs) may include manually removing the inner shell from the outer shell by pulling the inner shell in a direction extending from a first end (e.g., first end 58) to a second end (e.g., second end 60) of the inner shell. The inner shell may be retained within the cavity of the outer shell by a retention component (e.g., the outer retention component and/or the inner retention component described above). Removing the inner shell may include pulling the inner shell with enough force to overcome the force exerted by the retention component.

The method 600 of incubating gecko eggs may include conveying the inner shell to an incubation environment at operation 640. The incubation environment is an enclosure other than the environmental enclosure in which the egg removal device was provided. The incubation environment may be specially adapted to incubate the eggs laid in the inner shell. For example, a temperature, humidity, or other aspects of the incubation environment may vary from the environmental enclosure of operation 610. The eggs laid in the inner shell may be incubated within the inner shell. The method 600 of incubating gecko eggs may include incubating the gecko eggs within the inner shell. The method 600 of incubating gecko eggs may include the step of inserting a second inner shell into the outer shell of the gecko egg removal device (e.g., the method 600 of incubating gecko eggs may include inserting a second inner shell into the gecko egg removal device after a first inner shell has been removed and conveyed to an incubation environment).

Having now described some illustrative embodiments and embodiments, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one embodiment are not intended to be excluded from a similar role in other embodiments.

It should be noted that although method steps may be described in a specific order, it is understood that the order of these steps may differ from what is described. In a non-limiting example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. It is understood that all such variations are within the scope of the disclosure.

While this specification contains many specific embodiment details, these should not be construed as limitations on the scope of any inventions or of what may be claimed, but rather as descriptions of features specific to particular embodiments of the systems and methods described herein. Certain features that are described in this specification in the context of separate embodiments may also be embodied in combination in a single embodiment. Conversely, various features that are described in the context of a single embodiment may also be embodied in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate embodiments consisting of the items listed thereafter exclusively. In one embodiment, the systems and methods described herein consist of one, each combination of more than one, or all of the described elements, acts, or components.

As utilized herein with respect to numerical ranges, the terms “approximately,” “about,” “substantially,” “essentially,” and similar terms generally mean +/−10% of the disclosed values. When the terms “approximately,” “about,” “substantially,” “essentially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

Any references to embodiments or elements or acts of the systems and methods herein referred to in the singular may also embrace embodiments including a plurality of these elements, and any references in plural to any embodiment or element or act herein may also embrace embodiments including only a single element. References in the singular or plural form are not intended to limit the presently disclosed systems or methods, their components, acts, or elements to single or plural configurations. References to any act or element being based on any information, act, or element may include embodiments where the act or element is based at least in part on any information, act, or element.

Any embodiment disclosed herein may be combined with any other embodiment, and references to “an embodiment,” “some embodiments,” “an alternate embodiment,” “various embodiments,” “one embodiment,” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment, inclusively or exclusively, in any manner consistent with the aspects and embodiment disclosed herein.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes, and omissions may be made in the design, operating conditions and embodiment of the embodiments without departing from the scope of the present disclosure as expressed in the appended claims.

1. A gecko egg removal device comprising:
an outer shell comprising a tubular body defining a cavity, the outer shell further comprising:
a first end enclosed by an outer end wall configured to retain an inner shell; and
a second end configured to receive the inner shell, the second end longitudinally opposed to the first end;
a suspension system configured to couple the outer shell with an environmental enclosure; and
an inner shell removably inserted into the cavity, the inner shell comprising:
a first end enclosed by an inner end wall; and
a second end defining an opening for a gecko;
wherein the inner shell defines an interior cavity sized to receive a gecko and having an interior surface configured to support the gecko and a gecko egg.

2. The gecko egg removal device of claim 1, wherein the suspension system comprises:
a first magnet of a planar outer surface of the outer shell, the planar outer surface configured to couple with an interior surface of an environmental enclosure; and
a second magnet configured to couple with an exterior surface of the environmental enclosure to retain the outer shell in an elevated position.

3. The gecko egg removal device of claim 1, wherein:
the outer shell comprises a first magnet configured to magnetically couple with a second magnet of the inner shell to retain the inner shell within the cavity; and
the first magnet and the second magnet are configured to exert an attractive force sufficient to retain the inner shell within the cavity against gravity while permitting manual removal of the inner shell.

4. The gecko egg removal device of claim 3, wherein:
the first magnet is integral to the outer end wall; and
the second magnet is integral to the inner end wall.

5. The gecko egg removal device of claim 1, wherein the inner end wall defines a first plurality of apertures.

6. The gecko egg removal device of claim 5, wherein:
the outer end wall defines a second plurality of apertures;
the tubular body of the outer shell is a polygonal tubular body configured to receive a polygonal tubular body of the inner shell according to a plurality of relative rotations between the outer shell and the inner shell; and
the first plurality of apertures is configured to align with the second plurality of apertures according to each of the plurality of relative rotations.

7. The gecko egg removal device of claim 1, wherein:
the outer end wall defines a first plurality of apertures;
the inner end wall defines a second plurality of apertures; and
at least one of the first plurality of apertures aligns with at least one of the second plurality of apertures.

8. The gecko egg removal device of claim 1, wherein the tubular body of the outer shell defines one or more elongated apertures sized to permit manual grasping of the inner shell therethrough.

9. The gecko egg removal device of claim 1, wherein the tubular body of the outer shell is a hexagonal tubular body.

10. A gecko egg removal device comprising:
an outer shell comprising:
an inner surface defining a cavity configured to receive an inner shell, wherein the inner shell defines an interior surface configured to support a gecko and a gecko egg; and
a first portion of a suspension system configured to couple with a second portion of the suspension system; and
the second portion of the suspension system configured to couple the outer shell with an environmental enclosure.

11. The gecko egg removal device of claim 10, wherein the outer shell comprises a plurality of inner surfaces, each of the plurality of inner surfaces defining a cavity configured to receive an inner shell.

12. The gecko egg removal device of claim 10, wherein the outer shell further comprises a retention component configured to releasably retain the inner shell within the cavity.

13. The gecko egg removal device of claim 12, wherein the retention component comprises a first magnet of the inner surface configured to couple with a second magnet of the inner shell.

14. The gecko egg removal device of claim 10, wherein the first portion of the suspension system comprises a first magnet and the second portion of the suspension system comprises a second magnet configured to couple with the first magnet.

15. The gecko egg removal device of claim 10, wherein the inner shell comprises an inner ventilating portion.

16. The gecko egg removal device of claim 15, wherein the inner ventilating portion defines an aperture.

17. The gecko egg removal device of claim 10, wherein the outer shell comprises an outer ventilating portion.

18. The gecko egg removal device of claim 17, wherein the outer ventilating portion comprises at least one aperture in the outer shell.

19. The gecko egg removal device of claim 10, further comprising the inner shell.

20. (canceled)

21. A gecko egg removal device, comprising:
an inner shell configured to be removably inserted into an outer shell, the inner shell comprising:
a tubular body extending between a first end and second end;
an end wall enclosing the first end and defining one or more apertures therethrough; and
a magnet disposed on or within the end wall, the magnet configured to engage the outer shell;
wherein, the second end defines an opening for a gecko.
